(19) United States
(12) Patent Application Publication
(10) Pub. No.: US 2025/0095896 A1
(43) Pub. Date: Mar. 20, 2025

(54) SOLENOID DEVICE, MEDIUM TRANSPORT DEVICE, RECORDING DEVICE

(71) Applicant: SEIKO EPSON CORPORATION, Tokyo (JP)

(72) Inventors: Junya SHIBUYA, SHIOJIRI-SHI (JP); Keita HANAOKA, SHIOJIRI-SHI (JP); Tetsuji YATSUNAMI, OKAYA-SHI (JP)

(21) Appl. No.: 18/890,435

(22) Filed: Sep. 19, 2024

(30) Foreign Application Priority Data
Sep. 20, 2023 (JP) 2023-152046

(51) Int. Cl. H01F 7/16; B65H 5/06

(52) U.S. Cl. CPC H01F 7/16; B65H 5/062; B65H 2555/13; B65H 2801/06

(57) ABSTRACT

A solenoid device includes a solenoid having a plunger that is configured to perform a displacement operation in a first direction in which the plunger is retracted into a solenoid main body and in a second direction in which the plunger protrudes from the solenoid main body; a frame with which the solenoid is provided; and a contact section that the plunger comes into contact with when the plunger moves in the second direction, wherein the solenoid main body is attached to the frame via a first attachment section and the contact section is attached to the frame via a second attachment section.

The present application is based on, and claims priority from JP Application Serial Number 2023-152046, filed Sep. 20, 2023, the disclosure of which is hereby incorporated by reference herein in its entirety.

### BACKGROUND

### 1. Technical Field

The present disclosure relates to a solenoid device including a solenoid, and a medium transport device equipped with the solenoid device. The present disclosure also relates to a recording device equipped with the medium transport device.

### 2. Related Art

An example of a device that uses a solenoid as a power source is shown in JP-A-2013-069716. The solenoid described in JP-A-2013-069716 is attached to a frame that is fixed to the inside of an inversion type paper transport device. This solenoid has a plunger that is retracted into or protrudes from the main body of the solenoid. The frame is provided with a stopper that faces a tip end of the plunger. When the plunger protrudes, the tip end of the plunger contacts the stopper, and a protruding position of the plunger is set.

When the tip end of the plunger comes into contact with the stopper, impact on the stopper may be transmitted to the frame as vibration, so that the frame vibrates and generates noise. In the device described in JP-A-2013-069716, no consideration is given to such problems.

### SUMMARY

A solenoid device to solve the above problems in this disclosure includes a solenoid having a plunger that is configured to perform a displacement operation in a first direction in which the plunger is retracted into a solenoid main body and in a second direction in which the plunger protrudes from the solenoid main body; a frame with which the solenoid is provided; and a contact section that the plunger comes into contact with when the plunger moves in the second direction, wherein the solenoid main body is attached to the frame via a first attachment section and the contact section is attached to the frame via a second attachment section.

A medium transport device according to this disclosure includes a transport roller pair that nips and transports a medium and that has a first roller that comes into contact with a first surface of the medium and a second roller that comes into contact with a second surface of the medium opposite to the first surface of the medium; and a gate section that is switchable between a first state in which a medium transport path is closed at an upstream side of a medium transport direction from a nip position where the medium is nipped by the transport roller pair, and a second state in which the medium transport path is open, wherein the gate section is provided on a pivot member that is pivotable with respect to a first rotation shaft, which is a rotation shaft of the first roller, and the pivot member is driven by the solenoid device.

A recording device according to this disclosure includes a recording section that performs recording on a medium, and the medium transport device.

### BRIEF DESCRIPTION OF THE DRAWINGS

FIG. 1 is a diagram showing an entire medium transport path of a printer.

FIG. 2 is a diagram showing a part of the medium transport path of the printer.

FIG. 3 is a side view of a medium transport device when a gate section is in a first state.

FIG. 4 is a side view of the medium transport device when the gate section is in a second state.

FIG. 5 is a perspective view of the gate section, a drive roller, and a first rotation shaft in the first state.

FIG. 6 is a perspective view of a pivot member and a connecting member.

FIG. 7 is a perspective view of the medium transport device and the pivot member when the gate section is in the first state.

FIG. 8 is a perspective view of a solenoid device when the gate section is in the first state.

FIG. 9 is a perspective view of a solenoid and the pivot member that switch a state of the gate section.

FIG. 10 is an exploded perspective view of the solenoid device.

FIG. 11 is a perspective view of a frame.

FIG. 12 is a perspective view of a contact section viewed from below.

FIG. 13 is a cross-sectional view of the solenoid device that is cut in a Y-Z plane.

FIG. 14 is a plan view of the contact section as viewed from below.

FIG. 15 is a perspective view of a solenoid device in another embodiment.

FIG. 16 is an exploded perspective view of the solenoid device in said another embodiment.

FIG. 17 is a perspective view of a contact section in said another embodiment as viewed from below.

FIG. 18 is a plan view of the contact section in said another embodiment as viewed from below.

FIG. 19 is a cross-sectional view of the solenoid device in said another embodiment that is cut along the Y-Z plane.

FIG. 20 is an exploded perspective view of a solenoid device in still another embodiment.

FIG. 21 is a cross-sectional view of the solenoid device in the still another embodiment that is cut along in the Y-Z plane.

### DESCRIPTION OF EMBODIMENTS

Hereinafter, the present disclosure will be briefly described.

A solenoid device according to a first aspect includes a solenoid having a plunger that is configured to perform a displacement operation in a first direction in which the plunger is retracted into a solenoid main body and in a second direction in which the plunger protrudes from the solenoid main body; a frame with which the solenoid is provided; and a contact section that the plunger comes into contact with when the plunger moves in the second direction, wherein the solenoid main body is attached to the frame via a first attachment section and the contact section is attached to the frame via a second attachment section.

According to this aspect, the contact section is attached to the frame via the second attachment section. Thus, vibration caused by impact when the plunger comes into contact with the contact section will be is transmitted from the contact section to the frame via the second attachment section. By this, the frame is less likely to vibrate compared to a configuration where the plunger directly contacts the second attachment section, and noise is less likely to be generated by vibration of the frame.

A second aspect is an aspect according to the first aspect, wherein the contact section has a first end section that is an end section on a side where the plunger contacts and a second end section that is an opposite side end section of the first end section and that is located in the second direction with respect to the first end section and in a displacement direction of the plunger, a slit that is deformable when the plunger contacts the first end section, is provided between the first end section and the second end section and at a position that is closer to the first end section.

According to this aspect, a slit that is deformable when the plunger comes into contact with the first end section is provided between the first end section and the second end section and at a position closer to the first end section. Thus, impact when the plunger comes into contact with the contact section can be further suppressed by deformation of a part of the contact section. As a result, vibration generated by the impact is suppressed, and generation of the noise can be further suppressed.

The impact when the plunger comes into contact with the contact section can be suppressed, for example, by providing a cushioning material on a surface where the plunger contacts, but in this case, there is concern that the positioning accuracy of the plunger decreases. However, with the configuration in which a slit is provided between the first end section and the second end section, even if a part of the contact section is deformed, it returns to its original state. Therefore, it is easier to ensure the positioning accuracy of the plunger compared to a configuration with the cushioning material is provided.

A third aspect is an aspect according to the second aspect, wherein the slit overlaps a region that extends in the second direction from a movement region of the plunger.

According to this aspect, the slit overlaps a region that extends the movement region of the plunger in the second direction. Therefore, a part of the contact section where the slit is formed is easily deformed, and impact when the plunger comes into contact with the contact section can be effectively suppressed. As a result, vibration caused by the impact is effectively suppressed, and generation of the noise can be more effectively suppressed.

A fourth aspect is an aspect according to the first aspect, wherein in a displacement direction of the plunger, the frame is located in the first direction with respect to the contact section, the contact section has a first end section that is an end section on the side where the plunger contacts, a second end section that is an opposite side end section of the first end section and is located in the second direction with respect to the first end section, and a restricted surface, which is a portion that engages the second attachment section and that restricts a movement of the contact section in the second direction, and the restricted surface is provided between the first end section and the second end section and at a position closer to the second end section in the movement direction of the plunger.

When the plunger comes into contact with the contact section, the contact section attempts to move in the second direction, but the movement in the second direction is restricted by the restricted surface. Thus, vibration caused by impact when the plunger comes into contact with the contact section is transmitted to the second attachment section via the restricted surface, and then transmitted to the frame.

Here, in the displacement direction of the plunger, the frame is located in the first direction with respect to the contact section, so that the more the restricted surface is located in the second direction, the more the distance between the restricted surface and the frame can be secured. As a result, vibration caused by the impact is further damped and generation of the noise is further suppressed.
In this embodiment, the restricted surface is located between the first end section and the second end section and at the position closer to the second end section in the movement direction of the plunger. Therefore, the distance between the frame and the restricted surface can be secured. As a result, vibration caused by the impact is further damped, and generation of the noise can be further suppressed.
Note that this aspect is not limited to the first aspect above, and may be an aspect according to the second or third aspect above.

A fifth aspect is an aspect according to the first aspect, wherein a vibration damping member that dampens vibration is interposed between the contact section and the second attachment section.

According to this aspect, the vibration damping member that damps vibration is interposed between the contact section and the second attachment section. Therefore, vibration caused by the impact is further damped, and generation of the noise can be further suppressed.
Note that this aspect is not limited to the first aspect above, and may be according to any of the second to fourth aspects above.

A sixth aspect is an aspect according to the fifth aspect, wherein a first surface of the vibration damping member contacts the contact section, and a second surface of the vibration damping member, which is an opposite surface to the first surface, contacts the second attachment section.

According to this aspect, the first surface of the vibration damping member contacts the contact section, and the second surface of the vibration damping member, which is an opposite surface to the first surface, contacts the second attachment section. Therefore, vibration transmitted from a surface of the contact section, where the first surface contacts, to a surface of the second attachment section, where the second surface contacts, can be damped.

In addition, since the second surface is in contact with the second attachment section, it can damp vibration travelling through the second attachment section when vibration is travelling through the second attachment section.
The above can further suppress generation of the noise.

A seventh aspect is an aspect according to the first aspect, wherein the contact section is provided to the second attachment section in a state that has play in a direction that intersects a displacement direction of the plunger.

According to this aspect, the contact section is provided to the second attachment section in a state that has play in a direction that intersects a displacement direction of the plunger. Therefore, vibration transmitted from the contact section to the second attachment section can be suppressed, thereby further reducing the generation of the noise.
Note that this aspect is not limited to the first aspect above, and may be according to any of the second to sixth aspects above.

An eighth aspect is an aspect according to the second aspect, wherein in the displacement direction of the plunger, the frame is located in the first direction with respect to the contact section, the contact section has a restricted surface, which is a portion that engages the second attachment section and restricts movement of the contact section in the second direction, and the restricted surface is provided between the first end section and the second end section and at a position closer to the second end section in the movement direction of the plunger.

When the plunger comes into contact with the contact section, the contact section attempts to move in the second direction, but the movement in the second direction is restricted by the restricted surface. Thus, vibration caused by impact when the plunger comes into contact with the contact section is transmitted to the second attachment section via the restricted surface, and then transmitted to the frame.

Here, in the displacement direction of the plunger, the frame is located in the first direction with respect to the contact section, so that the more the restricted surface is located in the second direction, the more the distance between the restricted surface and the frame can be secured. As a result, vibration caused by the impact is further damped and generation of the noise is further suppressed.
In this embodiment, the restricted surface is located between the first end section and the second end section and at the position closer to the second end section in the movement direction of the plunger. Therefore, the distance between the frame and the restricted surface can be secured. As a result, vibration caused by the impact is further damped, and generation of the noise can be further suppressed.

A ninth aspect is an aspect according to the eighth aspect, wherein a vibration damping member that dampens vibration is interposed between the contact section and the second attachment section.

According to this aspect, the vibration damping member that damps vibration is interposed between the contact section and the second attachment section. Therefore, vibration caused by the impact is further damped, and generation of the noise can be further suppressed.

A tenth aspect is an aspect according to the ninth aspect, wherein, the first end section, the vibration damping member, the restricted surface, and the second end section are located along the second direction in this order.

According to this aspect, since the vibration damping member is located between the first end section and the restricted surface, vibration is transmitted to the second attachment section via the restricted surface, and is further transmitted to the frame. Therefore, vibration from the restricted surface toward the frame can be damped. As a result, vibration caused by the impact is further damped, and generation of the noise can be further suppressed.

An eleventh aspect is an aspect according to the second aspect, wherein a vibration damping member that dampens vibration is interposed between the contact section and the second attachment section.

According to this aspect, the vibration damping member that damps vibration is interposed between the contact section and the second attachment section. Therefore, vibration caused by the impact is further damped, and generation of the noise can be further suppressed.

A twelfth aspect is an aspect according to the first aspect, wherein the first attachment section and the second attachment section are integral.

According to this aspect, the first attachment section and the second attachment section are integral. Therefore, compared to a configuration where the first attachment section and second attachment section are separate, a positional relationship between the solenoid main body and the contact section is more precisely determined, thereby improving the positional accuracy of the plunger when the plunger is displaced in the second direction.
Note that this aspect is not limited to the first aspect above, and may be according to any of the second to eleventh aspects above.

A medium transport device according to a thirteenth aspect includes a transport roller pair that nips and transports a medium and that has a first roller that comes into contact with a first surface of the medium and a second roller that comes into contact with a second surface of the medium opposite to the first surface of the medium and a gate section that is switchable between a first state in which a medium transport path is closed at an upstream side of a medium transport direction from a nip position where the medium is nipped by the transport roller pair, and a second state in which the medium transport path is open, wherein the gate section is provided on a pivot member that is pivotable with respect to a first rotation shaft, which is a rotation shaft of the first roller, and the pivot member is driven by the solenoid device according to any one of the aspects 1 to 12.

According to this aspect, the medium transport device is capable of correcting skew of the medium by the gate section, and the pivot member provided with the gate section is driven by the solenoid device according to any one of the first to twelfth aspects, so that any one of the effects of the first to twelfth aspects described above can be obtained in the medium transport device.

A recording device according to a fourteenth aspect includes a recording section that performs recording on a medium, and the medium transport device according to the thirteenth aspect above.

According to this aspect, in a recording device that performs recording on a medium, it is possible to obtain the function and effect of any one of the first to twelfth aspects described above.

Hereinafter, the present disclosure will be specifically described.

Hereinafter, an inkjet printer 1 will be described that performs recording by ejecting ink, which is an example of liquid, onto a medium represented by recording paper. Hereinafter, the inkjet printer 1 will be referred to simply as a printer 1. The printer 1 is an example of a recording device.

An X-Y-Z coordinate system shown in each drawing is a Cartesian coordinate system. A Y-axis direction is a direction intersecting a transport direction of the medium, that is, a medium width direction, and is also a depth direction of the device. The Y-axis direction is also a rotation shaft direction of each roller described later. In the Y-axis direction, a +Y direction is from a device front surface toward a device rear surface, and a −Y direction is from the device rear surface toward the device front surface. An X-axis direction is a device width direction and, as viewed from the operator of the printer 1, a +X direction is to a left side and a −X direction is to a right side. A Z-axis direction is a vertical direction, that is, a device height direction, and a +Z direction is an upward direction and a −Z direction is a downward direction.

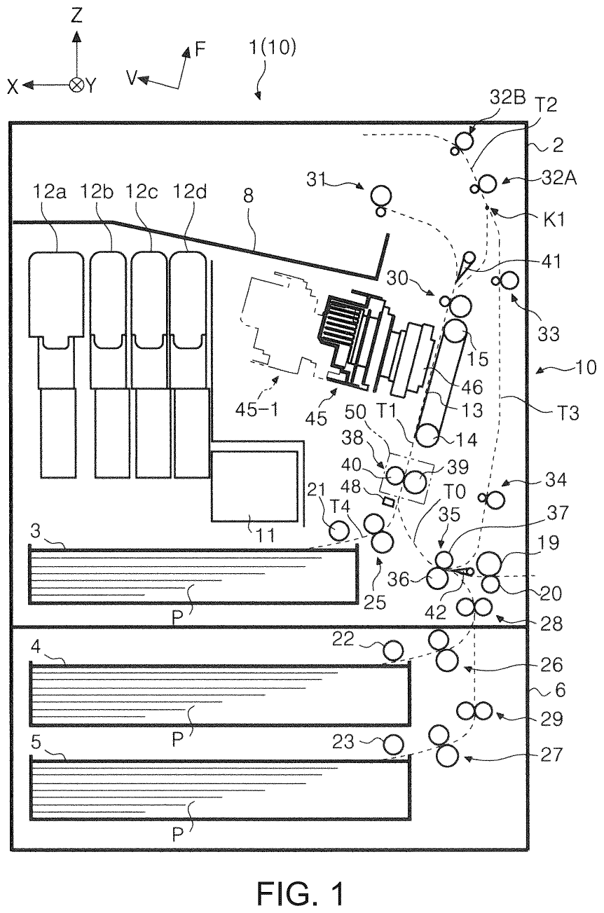

Hereinafter, a direction in which the medium is sent may be referred to as “downstream”, and an opposite direction of it may be referred to as “upstream”. In FIG. 1, a medium transport path is indicated by a broken line. In the printer 1, the medium is transported through the medium transport path indicated by the broken line.

A F-axis direction is a direction between a line head 46 and a transport belt 13 (to be described later), that is, a medium transport direction in a recording region. A +F direction is downstream in the transport direction, and a −F direction is upstream in the transport direction. V-axis directions are movement directions of a head unit 45. Of the V-axis directions, a +V direction is a direction in which the head unit 45 moves away from the transport belt 13, and a −V direction is a direction in which the head unit 45 moves closer to the transport belt 13.

The printer 1 has, in a lower portion of a device main body 2, a first medium cassette 3 that accommodates a medium, and is configured such that an additional unit 6 can be connected below the device main body 2. When the additional unit 6 is connected, a second medium cassette 4 and a third medium cassette 5 are located below the first medium cassette 3. The medium sent out from each medium cassette is transported along the medium transport path indicated by the broken line inside the printer 1.

Each of the medium cassettes is provided with a pickup roller that sends out the accommodated medium in the −X direction. The pickup rollers 21, 22, and 23 are pickup rollers provided for the first medium cassette 3, the second medium cassette 4, and the third medium cassette 5, respectively.

Each medium cassette is provided with a feed roller pair that feeds a medium, which was sent out in the −X direction, in an obliquely upward direction. The feed roller pairs 25, 26, and 27 are feed roller pairs provided for the first medium cassette 3, the second medium cassette 4, and the third medium cassette 5, respectively.
Note that hereinafter, unless otherwise explained, a “roller pair” is assumed to be composed of a drive roller, which is driven by a motor (not shown), and a driven roller, which is driven to rotate by contacting the drive roller.

A medium sent out from the third medium cassette 5 is sent to a transport roller pair 35 by transport roller pairs 29 and 28. A medium sent out from the second medium cassette 4 is sent to the transport roller pair 35 by the transport roller pair 28. A medium is sent by the transport roller pair 35 to a transport roller pair 38, which constitutes a medium transport device 50. Hereinafter, a section of the medium transport path from the transport roller pair 35 to the transport roller pair 38 will be referred to as a curved path T0. As shown in FIG. 1, the curved path T0 is a section in which the medium is curved so as to be convex downward.

Note that the transport roller pair 35 is comprised of a drive roller 36 that is driven by a motor (not shown) and a driven roller 37 that can be driven to rotate. The transport roller pair 38 is comprised of a drive roller 39 that is driven by a motor (not shown) and a driven roller 40 that can be driven to rotate. The drive roller 39 is an example of a first roller that comes into contact with a first surface of the medium, and the driven roller 40 is an example of a second roller that comes into contact with a second surface of medium.

Note that the medium sent out from the first medium cassette 3 is sent to the transport roller pair 38 without passing through the transport roller pair 35. Reference numeral T4 denotes the medium transport path from the first medium cassette 3 to the transport roller pair 38. Hereafter, this will be referred to as an upper cassette feed path T4.

A feed roller 19 and a separation roller 20, which are provided in the vicinity of the transport roller pair 35, are rollers that send out a medium from a feed tray (omitted from FIG. 1).

A medium that receives a feed force from the transport roller pair 38 is sent to a position between the line head 46, which is an example of a recording section, and the transport belt 13, that is, to a recording position facing the line head 46. Note that hereafter, the medium transport path from the transport roller pair 38 to a transport roller pair 30 will be referred to as a recording transport path T1.

The line head 46 constitutes the head unit 45. The line head 46 performs recording by ejecting ink, which is an example of liquid, onto a surface of the medium. The line head 46 is an ink ejection head configured such that nozzles for ejecting ink cover an entire region in the medium width direction, and is configured as an ink ejection head that is capable of recording on the entire region in the medium width direction without being moved in the medium width direction. However, the ink ejection head is not limited to this, and may be of a type that is mounted on a carriage and that ejects ink while moving in the medium width direction.

The head unit 45 is provided so as to be movable toward and away from the recording transport path T1, and is provided so as to be displaceable between the recording position indicated by a solid line in FIG. 1 and a retreat position where the head unit 45 is most retreated from the transport belt 13 as indicated by a two-dot chain line and reference numeral 45-1 in FIG. 1. When the head unit 45 is in the retreat position, the line head 46 is maintained by a maintenance means (not shown). A displacement direction of the head unit 45 is in the V-axis direction that in this embodiment is along an inclination of a discharge tray 8. The head unit 45 is located below the discharge tray 8 and on an upstream side in the medium discharge direction, and displaces along a bottom surface of the discharge tray 8.

Reference numerals 12a, 12b, 12c, and 12d denote ink containers that contain ink. Ink being ejected from the line head 46 is supplied to the line head 46 from each ink container via tubes (not shown). Each ink container is detachably provided. Reference numeral 11 denotes a waste liquid container that stores ink as waste liquid ejected from the line head 46 toward a flushing cap (not shown) for maintenance.

The transport belt 13 is an endless belt that is wound around a pulley 14 and a pulley 15, and rotates by at least one of the pulley 14 and the pulley 15 being driven by a motor (not shown). A medium is transported to a position facing the line head 46 while being attracted toward a belt surface of the transport belt 13. A known attraction methods such as an air suction method or an electrostatic attraction method can be used to attract a medium onto the transport belt 13.

The recording transport path T1, which passes a position facing the line head 46, forms an angle with respect to the horizontal direction and the vertical direction, and the medium is transported in an upward direction. This upward transport direction is a direction that includes the −X direction component and the +Z direction component in FIG. 1 and by such a configuration a horizontal dimension of the printer 1 can be suppressed.

Note that in this embodiment, the recording transport path T1 is set to an inclination angle in the range of 65° to 85° with respect to the horizontal direction, and more specifically, is set to the inclination angle of approximately 75°.

A medium on which recording has been performed by the line head 46 is sent further upward by the transport roller pair 30, which is located downstream from the transport belt 13. A flap 41 is provided downstream of the transport roller pair 30, and the flap 41 switches the transport direction of a medium. In a case when a medium is to be discharged as is, the flap 41 switches the transport path of the medium so that the medium directs toward an upper transport roller pair 31, and the medium is discharged toward the discharge tray 8 by the transport roller pair 31.

In a case when recording is to be performed on both sides of the medium, the transport direction of the medium is directed by the flap 41 toward a branch position K1. The medium passes through the branch position K1 and enters a switchback path T2. In this embodiment, the switchback path T2 is assumed to be a medium transport path to the upper side from the branch position K1. In the switchback path T2, a transport roller pair 32A and a roller pair 32B are provided. The medium that has entered the switchback path T2 is transported upward by the transport roller pairs 32A and 32B, and when the trailing edge of the medium passes the branch position K1, the rotation direction of the transport roller pairs 32A and 32B is switched and, by this, the medium is transported downward.

An inversion path T3 is connected to the switchback path T2. In this embodiment, the inversion path T3 is a path section from the branch position K1, through the transport roller pairs 33 and 34, to the transport roller pair 38. The inversion path T3 includes the curved path T0.

The medium transported downward from the branch position K1 reaches the transport roller pair 35 by receiving a feed force from the transport roller pairs 33 and 34, and then is sent toward a transport roller pair 38 by the transport roller pair 35. The inversion path T3 causes a surface of the medium that was facing downward, that is, a surface opposite to the previously recorded surface, to face upward.
Note that reference numeral 42 denotes a flap, and the flap 42 is provided so as to be pivotable around a pivot shaft (not shown) The flap 42 is normally in a lowered position, and guides a medium traveling along the inversion path T3 to the transport roller pair 35. On the other hand, a medium sent out from the second medium cassette 4 or the third medium cassette 5, which are below the transport roller pair 35, reaches the transport roller pair 35 by pushing up the flap 42.

A medium that was sent to the position facing the line head 46 via the inversion path T3, faces the line head 46 with a surface opposite to the surface that initially faced the line head 46. By this, the line head 46 can perform recording on both sides of the medium.

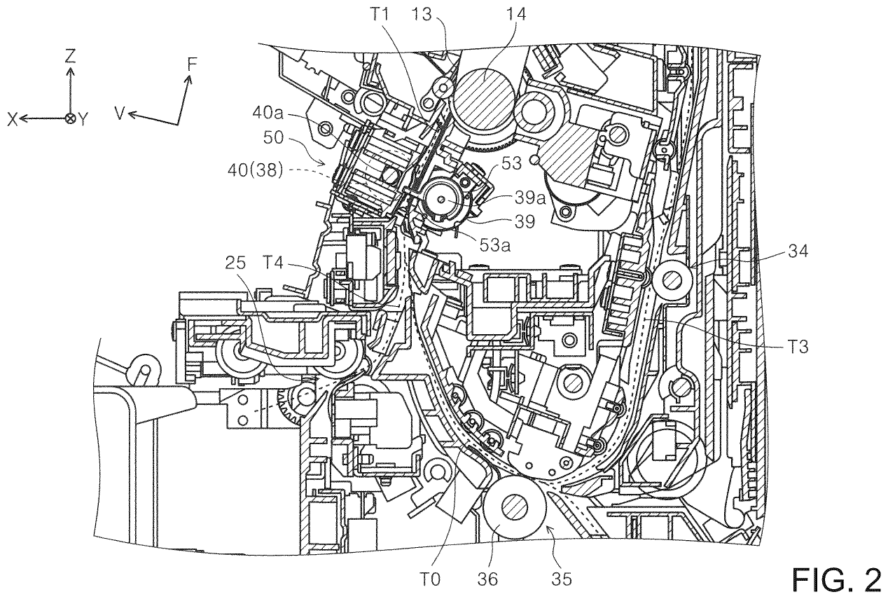

Next, the medium transport device 50 including the transport roller pair 38 will be described in detail with reference to FIG. 2 and the subsequent drawings. The medium transport device 50 has a transport roller pair 38, a gate section 35a, and a solenoid device 60 (to be described later).

In FIG. 2, the drive roller 39 constituting the transport roller pair 38 is provided on a first rotation shaft 39a. In this embodiment, the drive roller 39 is a toothed roller having a plurality of teeth (not shown) on its outer periphery.

The first rotation shaft 39a is provided with a pivot member 53. The pivot member 53 is provided so as to be pivotable with respect to the first rotation shaft 39a, and gate sections 53a are provided in the pivot member 53. The pivot member 53 is pivotally driven by the solenoid device 60 (to be described later) In this embodiment, the gate sections 53a are provided integrally with the pivot member 53, but the gate sections 53a may be provided in the pivot member 53 after being configured as separate members.

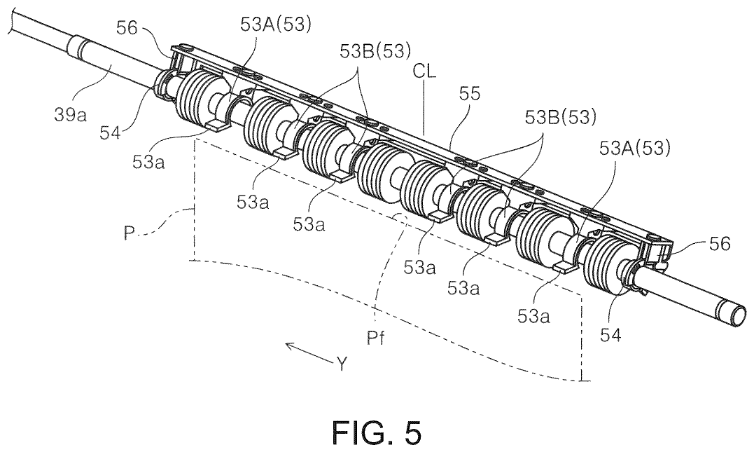

When the medium reaches the transport roller pair 38 through the curved path T0 or the upper cassette feed path T4, its leading edge Pf (see FIG. 5) comes into contact with the gate sections 53a. In this state, by a curved portion being formed on the upstream side of the leading edge Pf (see FIG. 5) of the medium, the leading edge Pf aligns with the gate sections 53a and skew feeding is corrected.

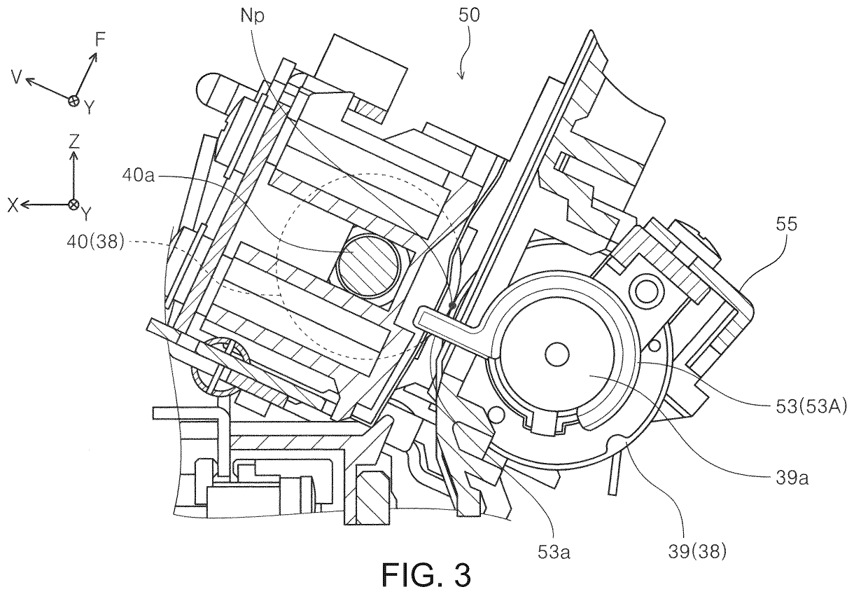

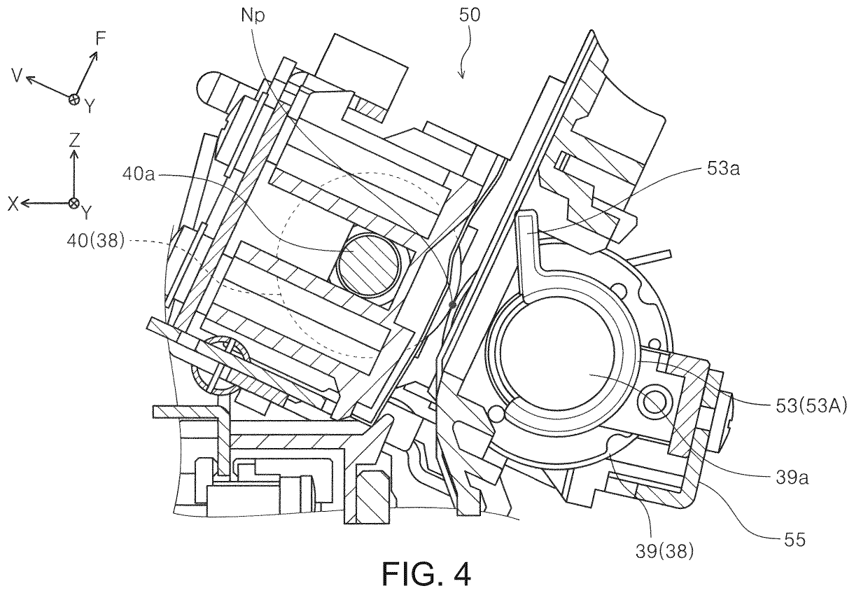

The gate sections 53a can be switched, by pivoting the pivot member 53, between a first state (state shown in FIGS. 2 and 3), in which the gate sections 53a block the curved path T0 or the upper cassette feed path T4 at an upstream side in the medium transport direction from the nip position where the medium is nipped by the transport roller pair 38, and a second state (state shown in FIG. 4), in which the gate sections 53a open the curved path T0 or the upper cassette feed path T4. When performing skew correction of the medium, the gate sections 53a are set to the first state, and when the skew correction is completed, the gate sections 53a are set to the second state.

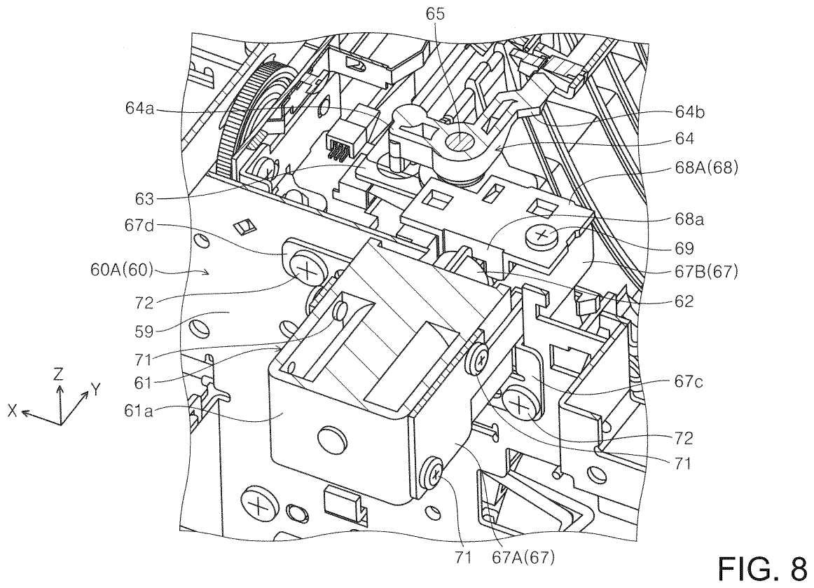

Note that in the first state of the gate sections 53a, the leading edge of the medium should contact the gate sections 53a at an upstream position from the nip position of the medium that is being nipped by the transport roller pair 38, so, for example, in FIG. 3, the nip position Np of the medium that is being nipped by the transport roller pair 38 may overlap the gate sections 53a.
Switching of the state of the gate sections 53a is controlled by a control section (not shown) by driving a solenoid 61 (see FIG. 8), which will be described later.

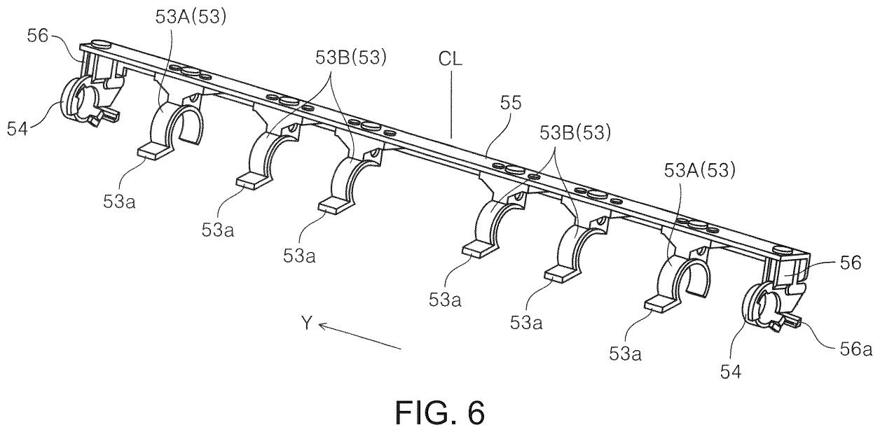

As shown in FIGS. 5 and 6, a plurality of pivot members 53 are provided at predetermined intervals along the rotation shaft direction of the first rotation shaft 39a. In FIGS. 5 and 6, reference numeral CL indicates a center position in the medium width direction, and the pivot members 53 are disposed so that the structure is bilaterally symmetrical with respect to the center position CL. In this embodiment, three pivot members 53 are disposed on both the left side and the right side of the center position CL. Note that when the term “rotation shaft direction” is used hereafter, it means the Y-axis direction. In this embodiment, the Y-axis direction is a rotation shaft direction of the first rotation shaft 39a, which is a rotation shaft of the drive roller 39, a rotation shaft direction of a second rotation shaft 40a (see FIGS. 2 to 4), which is a rotation shaft of the driven roller 40, and the medium width direction. A plurality of pivot members 53 are attached to a connecting frame 55 and, by this, all the pivot members 53 rotate simultaneously.

In this embodiment as shown in FIG. 6, the pivot member 53 includes pivot members 53A located at both ends in the rotation shaft direction, and pivot members 53B located between the two pivot members 53A. The pivot members 53A have regions that face the outer periphery surface of the first rotation shaft 39a by 180° or more along its circumferential direction, and have a shape that allows the first rotation shaft 39a to be inserted. The inner diameter of the pivot members 53A is substantially equal to or slightly larger than the outer diameter of the first rotation shaft 39a. By this, the pivot members 53A can pivot while being in contact with the outer periphery surface of the first rotation shaft 39a.

In contrast, the pivot members 53B have regions that face the outer periphery surface of the first rotation shaft 39a by less than 1800 along its circumferential direction, and have an inner diameter larger than the inner diameter of the pivot members 53A. By this, the pivot members 53B pivot around the first rotation shaft 39a in a state where the pivot members 53B are not in contact with the outer periphery surface of the first rotation shaft 39a or in a state where the pivot members 53B are in slight contact with the outer periphery surface of the first rotation shaft 39a.

With the above configuration, when the pivot members 53A and 53B pivot integrally via the connecting frame 55, the pivot members 53A, which are located at both ends in the rotation shaft direction, come into contact with the outer periphery surface of the first rotation shaft 39a. Assuming that all of the plurality of pivot members 53 are pivot members 53A, there is a concern that, due to dimensional error, gouging may occur and smooth rotation cannot be achieved during pivoting. However, as described above, it is designed so that the pivot members 53A located at both ends in the rotation shaft direction are in contact with the outer periphery surface of the first rotation shaft 39a. Thus, all of the pivot members 53 can pivot smoothly. The positions of the gate sections 53a in the medium transport direction are designed to be equal for the pivot members 53A and the pivot members 53B.

Note that when it is not necessary to distinguish the pivot member 53A from the pivot member 53B in this specification, they are collectively referred to as pivot members 53.

Attachment members 56 are provided at both ends of the connecting frame 55 in the rotation shaft direction, and grounding members 54 are provided to the attachment members 56. The grounding members 54 have a ring shape through which the first rotation shaft 39a is inserted, are formed from sintered metal, and are electrically connected to a grounding member (not shown) to discharge static electricity from the first rotation shaft 39a to the outside. However, the inner diameter of the grounding members 54 is set with a margin with respect to the outer diameter of the first rotation shaft 39a. Therefore, when the pivot members 53A and 53B and the grounding members 54 rotate integrally, the pivot members 53A are mainly in contact with the first rotation shaft 39a.

In the −Y direction side of the attachment member 56, a pressed section 56a is formed so as to protrude in the −Y direction.

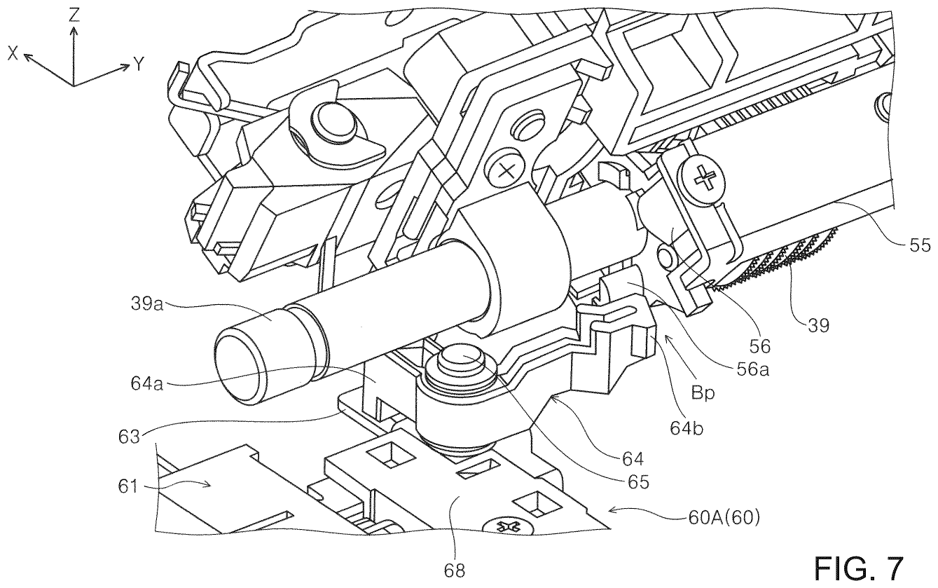

Here, in a region around the −Y direction end section of the first rotation shaft 39a, a pivot cam 64 is provided as shown in FIG. 7. When the pressed section 56a is pressed by the pivot cam 64 in a direction of arrow Bp, the pivot members 53 pivot in a clockwise direction in FIG. 3 from the state shown in FIG. 3, and the gate sections 53a are switched from the first state to the second state. Note that a pressing force in the counterclockwise direction in FIG. 3 is being applied to the connecting frame 55 by a pressing member (not shown), such as a torsion spring. When the pressing against the pressed section 56a by the pivot cam 64 is released, the pivot member 53 pivots in a counter-clockwise direction from the state shown in FIG. 4, and the gate sections 53a are switched from the second state to the first state.

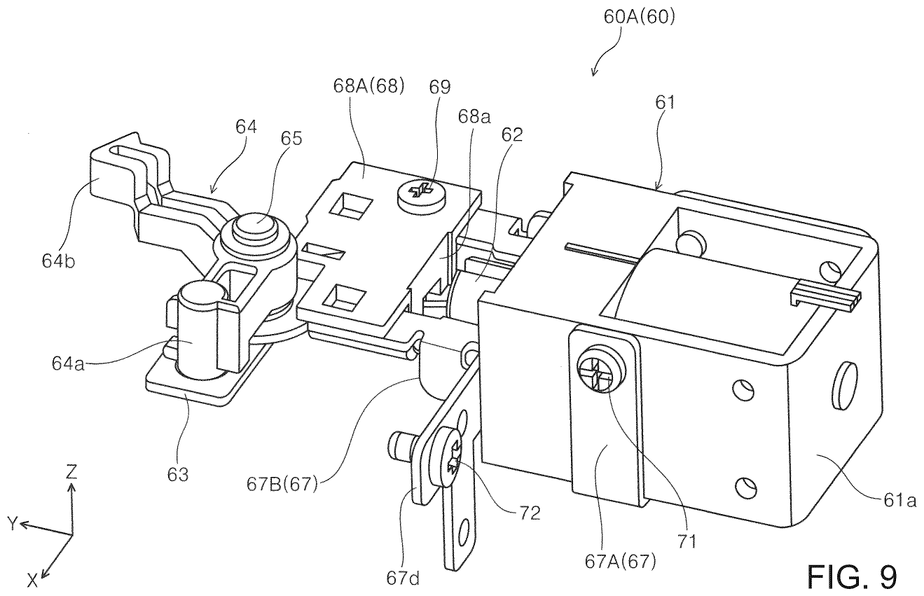

As shown in FIGS. 7, 8, and 9, the pivot cam 64 is provided so as to be pivotable around a pivot shaft 65. In this embodiment, the pivot shaft 65 extends along the Z-axis direction. The pivot cam 64 has a first engagement section 64a and a second engagement section 64b extending from the pivot shaft 65. The second engagement section 64b is a portion that presses the pressed section 56a, and the first engagement section 64a is a portion that engages with an engagement member 63.

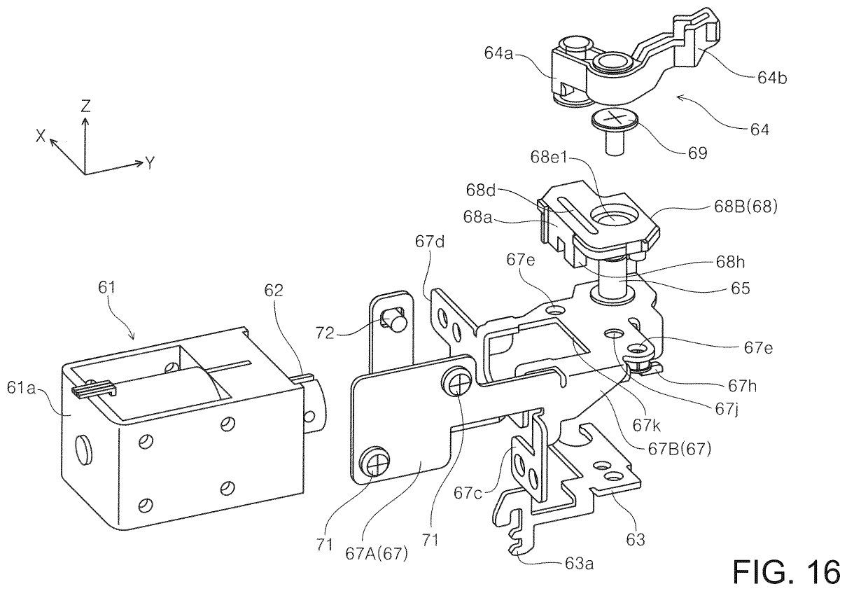

Although the entire shape of the engagement member 63 is not visible in FIGS. 7 and 8, the engagement member 63 is attached to a plunger 62 of the solenoid 61. The engagement member 63 is displaced in the Y-axis direction by displacing the plunger 62 of the solenoid 61 in the Y-axis direction and, by this, the pivot cam 64 pivots around the pivot shaft 65. The entire shape of the engagement member 63 is shown in FIG. 16.
The pivot shaft 65 is provided on an attachment frame 67, and the solenoid 61 is also attached to the attachment frame 67.

Hereinafter, the solenoid device 60 including the solenoid 61 will be further described. Note that there are several embodiments of the solenoid device, and each embodiment is distinguished by adding a capital letter of alphabet letter to the reference numeral 60. When there is no need to distinguish between the embodiments, they are collectively referred to as the solenoid device 60.

The solenoid device 60 has a frame 59, the solenoid 61, an attachment frame 67, and a contact section 68. Note that there are several embodiments of the contact section, and each embodiment is distinguished by adding a capital letter of the alphabet to the reference numeral 68. When there is no need to distinguish between the embodiments, they are collectively referred to the contact section 68 by using the reference numeral 68.
The frame 59 forms a base body of the solenoid device 60 and forms a frame surface along an X-Z plane. The frame 59 is made of metal plate material in this embodiment.

The solenoid 61 according to this embodiment has a plunger 62 that is displaceable along the Y-axis direction. The solenoid 61 is configured so that the plunger 62 is displaced by switching its energization direction. The +Y direction is the returning direction of the plunger 62, and the −Y direction is the holding direction of the plunger 62. The control section (not shown) of the printer 1 drives the solenoid 61 by switching the energization direction for the solenoid 61, and by this, the first state and the second state of the gate section 53a described above are switched.

The solenoid 61 is attached to the frame 59 via the attachment frame 67. The attachment frame 67 has a first attachment section 67A that is a portion where a main body 61a of the solenoid 61 is attached, and a second attachment section 67B that is a portion where the contact section 68 is attached. In this embodiment, the first attachment section 67A and the second attachment section 67B are integrally provided. Therefore, compared to a configuration where the first attachment section 67A and the second attachment section 67B are separate each other, the positional relationship between the main body 61a of the solenoid 61 and the contact section 68 is more precisely determined, and thus a positional accuracy of the plunger 62 when the plunger 62 is displaced in the +Y direction is improved. Note that although the first attachment section 67A and the second attachment section 67B are provided as a single member in this embodiment, the first attachment section 67A and the second attachment section 67B may be separate members.

The attachment frame 67 is made of metal plate material in this embodiment.

As shown in FIGS. 8 to 10, the first attachment section 67A has a shape so as to sandwich the main body 61a of the solenoid 61 in the X-axis direction, and in this embodiment the main body 61a is fixed to the first attachment section 67A by three solenoid fixing screws 71.

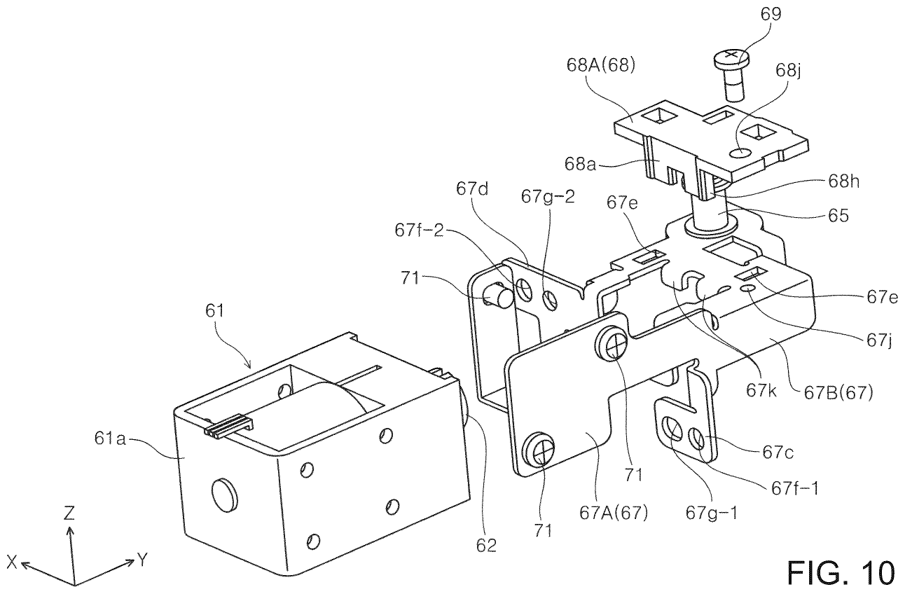

The second attachment section 67B has a shape so as to be capable of supporting the contact section 68 in the X-Y plane, and the contact section 68 is fixed to the second attachment section 67B by one contact section fixing screw 69. The contact section fixing screw 69 passes through a screw insertion hole 68j formed in a contact section 68A in FIG. 10, and fits into a screw hole formed in the second attachment section 67B.

The attachment frame 67 is integrally provided with frame fixing sections 67c and 67d that form a plane parallel to the X-Z plane, and the frame fixing sections 67c and 67d are fixed to the frame 59 by frame fixing screws 72.

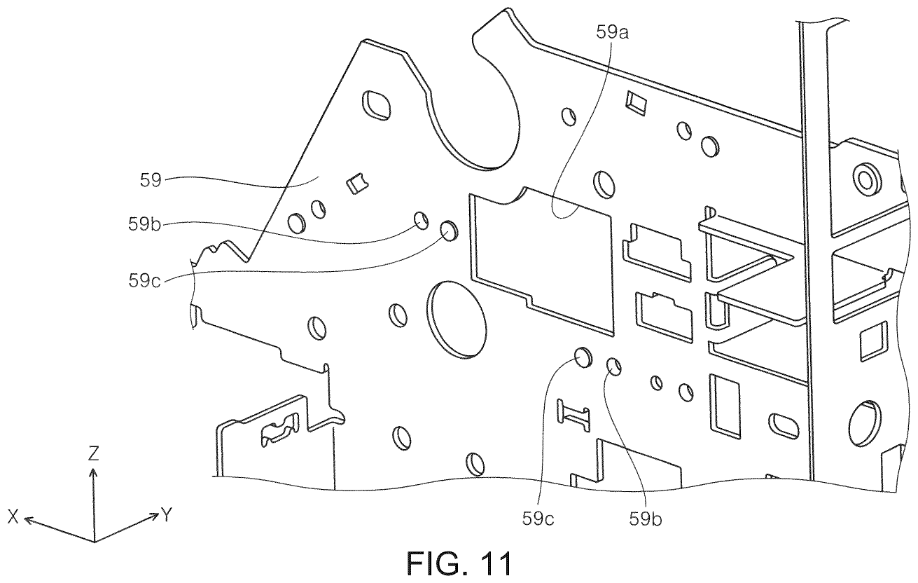

Note that in FIG. 10, reference numerals 67f-1 and 67f-2 denote screw insertion holes through which the frame fixing screws 72 are inserted. The screw insertion hole 67f-1 is a substantially true circle shape, and the screw insertion hole 67f-2 is formed as an elongated hole, which is elongated in the X-axis direction, and, by this, dimensional tolerances can be absorbed. In FIG. 11, reference numerals 59b denote screw holes into which the frame fixing screws 72 fit.

Note that as shown in FIG. 11, two positioning bosses 59c are formed in the frame 59. In the attachment frame 67, as shown in FIG. 10, a positioning hole 67g-1 is formed in the frame fixing section 67c and a positioning hole 67g-2 is formed in the frame fixing section 67d. One of the two positioning bosses 59c of the frame 59 fits into the positioning hole 67g-1 of the frame fixing section 67c, and the other fits into the positioning hole 67g-2 of the frame fixing section 67d.

The positioning hole 67g-2 is a substantially true circle shape, and the positioning hole 67g-1 is formed as an elongated hole, which is long in the X-axis direction and, by this, dimensional tolerances can be absorbed.
Reference numeral 59a in FIG. 11 denotes an opening through which the main body 61a of the solenoid 61 can pass.

The second attachment section 67B has two positioning holes 67e as shown in FIG. 10.

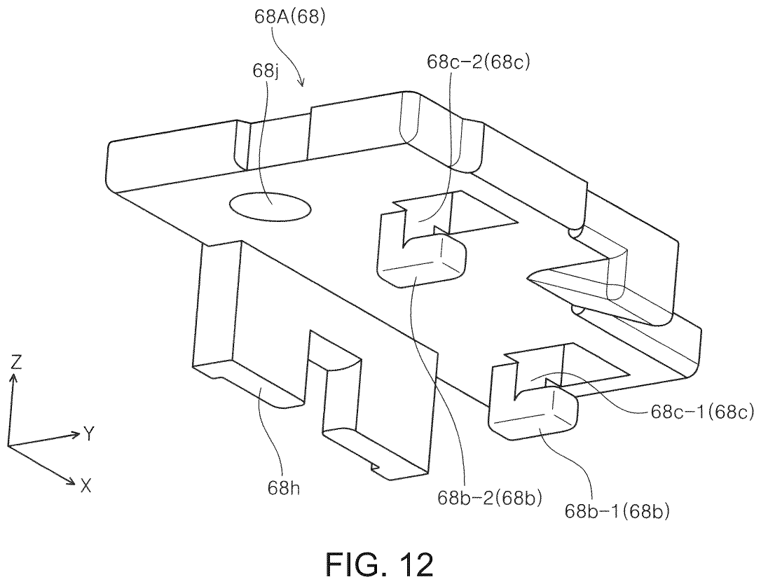

The solenoid device 60A according to the first embodiment has the contact section 68A. The contact section 68A has two restricted sections 68b that, as shown in FIG. 12, are formed in a hooked shape. The restricted sections 68b of the contact section 68A can enter the positioning holes 67e of the second attachment section 67B.
In FIG. 12, reference numerals 68c denote surfaces of a portion of the restricted sections 68b, that is, restricted surfaces. The contact section 68A is restricted from moving in the +Y direction by the restricted surfaces 68c by contacting +Y direction edges of the positioning holes 67e.
Note that of the two restricted sections 68b, the restricted section 68b located in the +X direction is denoted by reference numeral 68b-1 and the restricted section 68b located in the −X direction is denoted by reference numeral 68b-2. Similarly, of the two restricted surfaces 68c, the restricted surface 68c located in the +X direction is denoted by reference numeral 68c-1 and the restricted surface 68c located in the −X direction is denoted by reference numeral 68c-2.

As shown in FIGS. 8 and 10, the contact section 68A has a contact surface 68a that is a surface parallel to the X-Z plane. The contact surface 68a is a surface that the tip end of the plunger 62 of the solenoid 61 contacts when the plunger 62 is displaced in the +Y direction, and defines the displacement limit of the plunger 62 in the +Y direction.

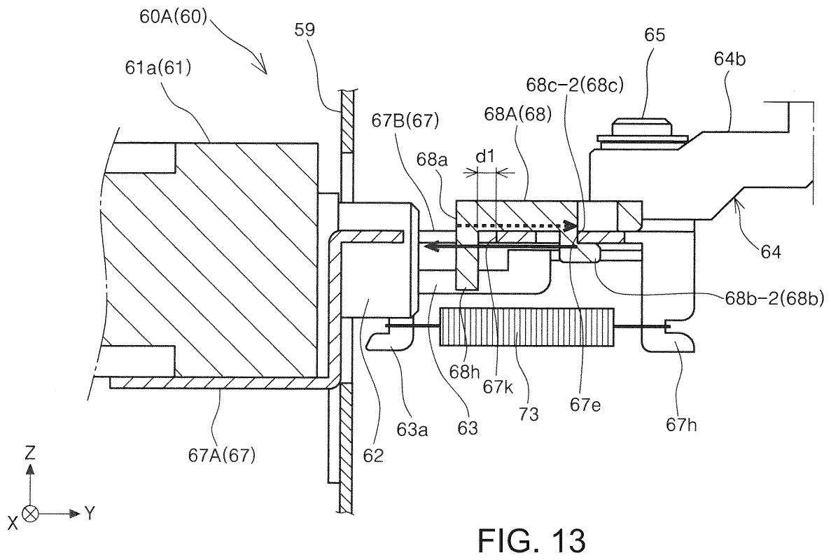

Note that the engagement member 63, which is attached to the plunger 62, is provided with a spring-hook section 63a as shown in FIG. 13. A spring-hook section 67h is formed on the attachment frame 67, and a coil spring 73, which is an example of a pressing member, is provided between the spring-hook section 63a and the spring-hook section 67h. The coil spring 73 applies pressing force in the +Y direction to the plunger 62 and assists in the displacement of the plunger 62 in the +Y direction.

When the plunger 62 is displaced in the +Y direction, the tip end of the plunger 62 comes into contact with the contact surface 68a as described above. A broken line arrow in FIG. 13 shows transmission of vibration caused by the plunger 62 contacting the contact surface 68a. Because the restricted surfaces 68c are in contact with the +Y direction edges of the positioning holes 67e, this vibration is transmitted to the attachment frame 67 and then goes towards the frame 59 as shown by a solid line arrow. If this vibration is transmitted to the frame 59, vibration of the frame 59 may cause noise.

Note that in FIG. 13, reference numeral d1 denotes a distance between a wall section 68h, which forms the contact surface 68a, and an edge section 67k, which is a portion of the second attachment section 67B facing the wall section 68h. By provision of the distance d1, impact when the plunger 62 comes into contact with the contact surface 68a is transmitted to the second attachment section 67B via the restricted surfaces 68c, and not to the wall section 68h.
The screw insertion hole 68j, through which the contact section fixing screw 69 (see FIG. 10) is inserted, is formed with a margin with respect to an outer diameter of the contact section fixing screw 69. Therefore, vibration is not transmitted from the inner circumferential surface of the screw insertion hole 68j to the outer peripheral surface of the contact section fixing screw 69, and the impact when the plunger 62 comes into contact with the contact surface 68a is transmitted to the second attachment section 67B via the restricted surfaces 68c.
The above also applies to other embodiments to be described later.

The contact section 68 is attached to the frame 59 via the second attachment section 67B. Thus, the vibration caused by the impact when the plunger 62 comes into contact with the contact section 68 is transmitted from the contact section 68 to the frame 59 via the second attachment section 67B as described above. By this, the frame 59 is less likely to vibrate compared to a configuration where the plunger 62 directly contacts the second attachment section 67B, and noise caused by the frame 59 vibration can be suppressed.

Note that from such a perspective, it is desirable that the contact section 68 is formed of a material that is at least less elastic than the frame 59. In this embodiment, the contact section 68 is formed of resin material, and the frame 59 is formed of metal material. However, the contact section 68 and the frame 59 may be formed of the same material.

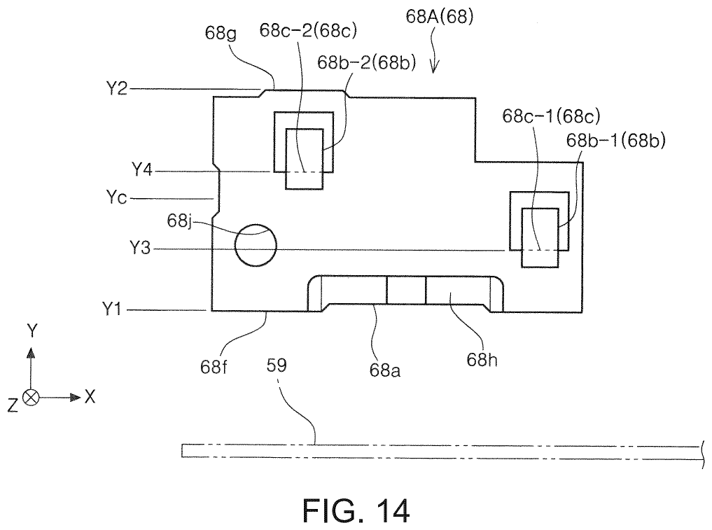

Next, FIG. 14 shows a positional relationship between the frame 59 and the two restricted surfaces 68c.

In this embodiment, the frame 59 is located in the −Y direction with respect to the contact section 68 in the displacement direction of the plunger 62, that is, in the Y-axis direction. Reference numeral 68f is a −Y direction end section of the contact section 68, that is, a first end section that is the end section on the side that the plunger 62 contacts, and reference numeral 68g is a +Y direction end section of the contact section 68, that is, a second end section that is opposite to the first end section 68f. The −Y direction is an example of a first direction, and the +Y direction is an example of a second direction.
Of the two restricted surfaces 68c engaged with the second attachment section 67B, the restricted surface 68c-2 is provided between the first end section 68f and the second end section 68g and at a position closer to the second end section 68g with respect the Y-axis direction. In FIG. 14, reference numeral Y1 indicates a position of the first end section 68f in the Y-axis direction, reference numeral Y2 indicates a position of the second end section 68g in the Y-axis direction, and reference numeral Yc indicates an intermediate position between the first end section 68f and the second end section 68g. Reference numeral Y3 indicates a position of the restricted surface 68c-1 in the Y-axis direction, reference numeral Y4 indicates a position of the restricted surface 68c-2 in the Y-axis direction. As shown in the drawing, the position Y4 is located in the +Y direction from the position Yc, that is, is closer to the second end section 68g than is the position Yc.

By this, the following function and effect can be obtained.

When the plunger 62 comes into contact with the contact section 68, the contact section 68 attempts to move in the +Y direction. Here, in the Y-axis direction, the frame 59 is located in the −Y direction with respect to the contact section 68. Thus, the more the restricted surface 68c is located in the +Y direction, the greater the distance that can be secured between the restricted surface 68c and the frame 59. As a result, vibration caused by the impact is further damped, and generation of noise can be further suppressed.
In this embodiment, the restricted surface 68c-2 is provided between the first end section 68f and the second end section 68g and at a position close to the second end section 68g in the Y-axis direction, which is a movement direction of the plunger 62. Therefore, a distance can be secured between the restricted surface 68c-2 and the frame 59. As a result, vibration caused by the impact is further damped, and generation of noise can be further suppressed.

Note that the restricted surface 68c-1 in this embodiment is located between the first end section 68f and the second end section 68g and at the position closer to the first end section 68f. However, the restricted surface 68c-1 may be located at a position closer to the second end section 68g, similar to the restricted surface 68c-2. In this embodiment, the contact section 68 has the two restricted surfaces 68c, but it may have one restricted surface 68c or three or more restricted surfaces 68c. At that time, all the restricted surfaces 68c may be located between the first end section 68f and the second end section 68g and at positions closer to the second end section 68g, or only a part of the restricted surfaces 68c may be located at a position closer to the second end section 68g.

Note that the second end section 68g may be used as the restricted surface 68c.

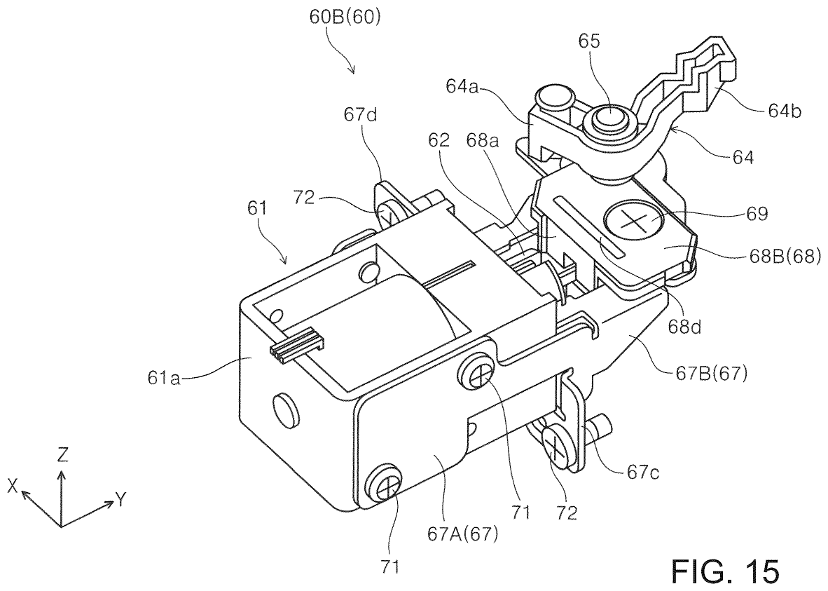

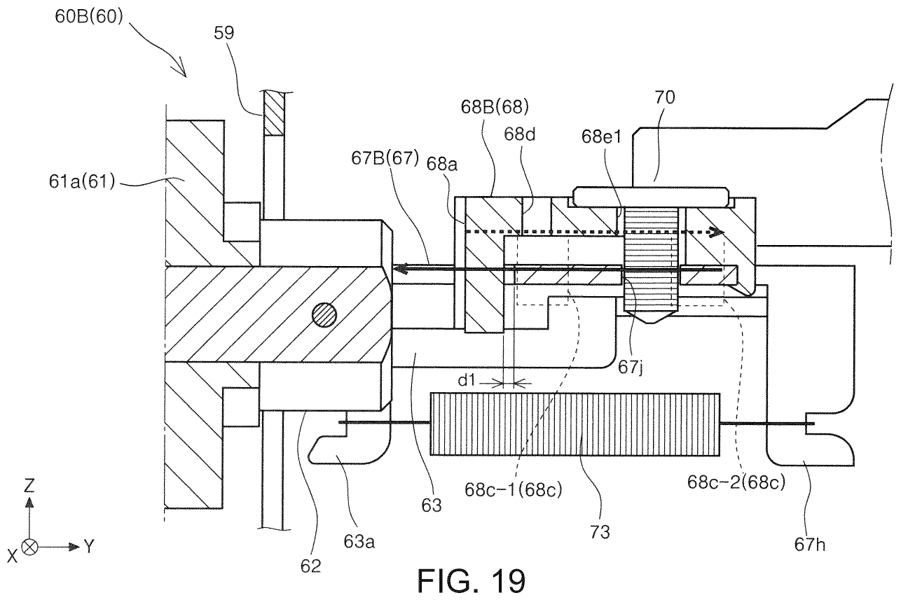

Next, a solenoid device 60B according to a second embodiment will be described with reference to FIGS. 15 to 19. Note that in the following description, the same components as those described above are denoted by the same reference numerals, and duplicate description will be avoided.

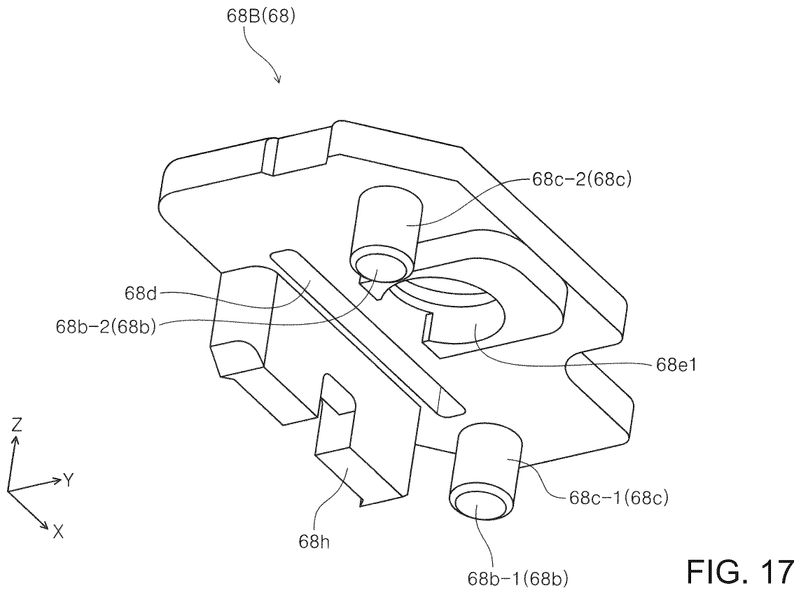

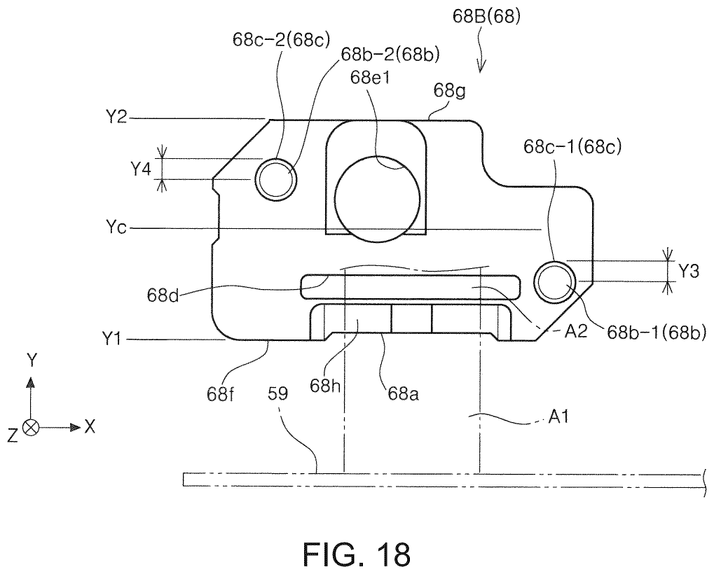

The solenoid device 60B has a contact section 68B instead of the contact section 68A described above. The contact section 68B has restricted sections 68b as shown in FIG. 17. The restricted sections 68b according to this embodiment is formed in a boss shape, and the restricted surfaces 68c are, of the outer periphery surface of the restricted sections 68b, surfaces that are visible from the +Y direction. In other words, in this embodiment, the restricted surfaces 68c are arc-shaped surfaces.
In FIG. 18, the restricted surfaces 68c-2 are provided at a position between the first end section 68f and the second end section 68g and closer to the second end section 68g in the Y-axis direction, similar to the description with reference to FIG. 14.
Note that the contact section 68B has a screw insertion hole 68e1 through which the contact section fixing screw 69 is inserted.

The contact section 68B has a slit 68d that extends in the X-axis direction at a position between the first end section 68f and the second end section 68g and closer to the first end section 68f. By this, when the tip end of the plunger 62 comes into contact with the contact surface 68a, the wall section 68h forming the contact surface 68a can be temporarily deformed in the +Y direction.

By this, impact when the plunger 62 comes into contact with the contact section 68B can be further suppressed. As a result, vibration caused by the impact is suppressed, and noise caused by the frame 59 can be further suppressed.
The impact when the plunger 62 comes into contact with the contact section 68B can be suppressed, for example, by providing a cushioning material on the contact surface 68a. However, in this case, there is concern that a positioning accuracy of the plunger 62 may be reduced. However, a slit 68d is provided between the first end section 68f and the second end section 68g, and the wall section 68h is configured to return to its original state after being temporarily deformed. By this, it is easier to ensure the positioning accuracy of the plunger 62 compared to the configuration in which cushioning material is provided.

Note that in this embodiment, the slit 68d overlaps with a region A2 that is obtained by extending the movement region A1 of the plunger 62 in the +Y direction. By this, the impact when the plunger 62 comes into contact with the contact section 68B can be effectively suppressed. As a result, the vibration caused by the impact is effectively suppressed, and thus the noise caused by the frame 59 can be more effectively suppressed.

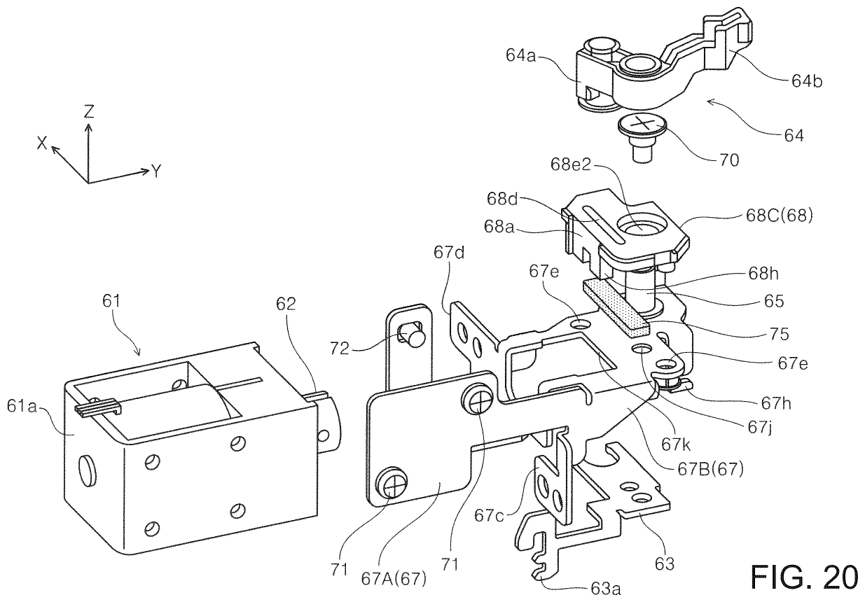

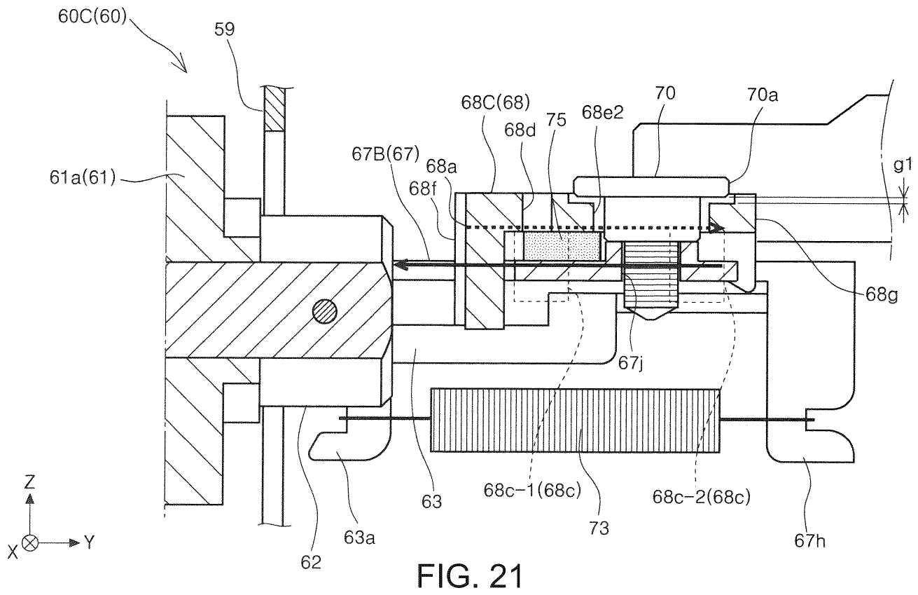

Next, a solenoid device 60C according to a third embodiment will be described with reference to FIGS. 20 and 21. The solenoid device 60C is different from the solenoid device 60B described above that it has a vibration damping member 75 and it uses a shoulder screw as a contact section fixing screw 70, which fixes the contact section 68C to the second attachment section 67B.

The contact section 68C has a screw insertion hole 68e2 through which the contact section fixing screw 70 is inserted. As shown in FIG. 21, the screw insertion hole 68e2 is formed in a stepped shape so as to correspond to the shoulder screw, which is the contact section fixing screw 70.

When the contact section fixing screw 70 fits into a screw hole 67j, a gap g1 is formed between a flange section 70a of the contact section fixing screw 70 and a stepped portion of the screw insertion hole 68e2.

The vibration damping member 75 is provided between the contact section 68C and the second attachment section 67B. The vibration damping member 75 is an elastic member, and can employ elastic materials such as sponge or rubber as examples.

The vibration damping member 75, which dampens vibration, is interposed between the contact section 68C and the second attachment section 67B in this manner, so that vibration caused by impact when the plunger 62 comes into contact with the contact surface 68a is further damped, and generation of noise caused by the frame 59 can be further suppressed.

The vibration damping member 75 has a first surface, which is a surface in the +Z direction of it, in contact with the −Z direction surface of the contact section 68C. The vibration damping member 75 has a second surface, which is a surface in the −Z direction of it and is opposite to the first surface, in contact with the +Z direction surface of the second attachment section 67B. By this, vibration being transmitted from the −Z direction surface of the contact section 68C to the +Z direction surface of the second attachment section 67B can be dampened.

In addition, when vibration is transmitted through the second attachment section 67B as indicated by a solid line arrow, the −Z direction surface of the vibration damping member 75 is in contact with the second attachment section 67B, so that the vibration transmitted through the second attachment section 67B can be dampened.
As a result of the above, generation of noise caused by the frame 59 can be further suppressed.

In the contact section 68C, the gap g1 is formed between the flange section 70a of the contact section fixing screw 70 and the stepped portion of the screw insertion hole 68e2. By this, the contact section 68C can be provided to the second attachment section 67B in a state where the contact section 68C has play in the Z-axis direction, that is, in a direction that intersects the displacement direction of the plunger 62. As a result, vibration transmitted from the contact section 68C to the second attachment section 67B can be suppressed, and generation of noise caused by the frame 59 can be further suppressed.

As shown in FIG. 21, the first end section 68f, the vibration damping member 75, the restricted surface 68c-2, the second end section 68g, are located along the +Y direction in this order. In this configuration, the vibration damping member 75 is located between the first end section 68f and the restricted surface 68c-2. By this, the vibration is transmitted to the second attachment section 67B via the restricted surface 68c-2, and then transmitted to the frame 59. In this configuration, the vibration that goes toward the frame 59 from the restricted surface 68c-2 can be dampened. As a result, generation of noise caused by the frame 59 can be further suppressed.

Note that in the solenoid device 60A according to the first embodiment described above, the contact section 68A may be provided with a slit similar to the slit 60d formed in the contact section 68B and the contact section 68C.

In the solenoid device 60A according to the first embodiment described above, the vibration damping member 75, which was described with reference to FIGS. 20 and 21, may be provided between the contact section 68A and the second attachment section 67B.
In the solenoid device 60A according to the first embodiment described above, the contact section fixing screw 69 may be a shoulder screw like the contact section fixing screw 70 described with reference to FIGS. 20 and 21, and the gap g1 described with reference to FIG. 21 may be provided.

In the solenoid device 60C according to the third embodiment described above, the slit 68d may omitted from the contact section 68C.

In the solenoid device 60C according to the third embodiment described above, the vibration damping member 75 may be omitted. In the solenoid device 60C according to the third embodiment described above, the contact section fixing screw 70, which is a shoulder screw, may be a normal screw, and the gap g1 described with reference to FIG. 21 may be omitted.
In other words, in the solenoid device 60C according to the third embodiment described above, at least one of the slit 68d, the vibration damping member 75, and the contact section fixing screw 70, which is a shoulder screw, may be employed, or any two of them may be employed.

This disclosure is not limited to the embodiments described above, and various modifications are possible within the scope of the application described in the claims, and it goes without saying that these are also included within the scope of this disclosure.

What is claimed is:

1. A solenoid device comprising:
a solenoid having a plunger that is configured to perform a displacement operation in a first direction in which the plunger is retracted into a solenoid main body and in a second direction in which the plunger protrudes from the solenoid main body;
a frame with which the solenoid is provided; and
a contact section that the plunger comes into contact with when the plunger moves in the second direction, wherein
the solenoid main body is attached to the frame via a first attachment section and
the contact section is attached to the frame via a second attachment section.

2. The solenoid device according to claim 1, wherein
the contact section has
a first end section that is an end section on a side where the plunger contacts and
a second end section that is an opposite side end section of the first end section and that is located in the second direction with respect to the first end section and
in a displacement direction of the plunger, a slit that is deformable when the plunger contacts the first end section, is provided between the first end section and the second end section and at a position that is closer to the first end section.

3. The solenoid device according to claim 2, wherein
the slit overlaps a region that extends in the second direction from a movement region of the plunger.

4. The solenoid device according to claim 1, wherein
in a displacement direction of the plunger, the frame is located in the first direction with respect to the contact section,
the contact section has
a first end section that is an end section on a side where the plunger contacts,
a second end section that is an opposite side end section of the first end section and that is located in the second direction with respect to the first end section, and
a restricted surface, which is a portion that engages the second attachment section and that restricts a movement of the contact section in the second direction, and
the restricted surface is provided between the first end section and the second end section and at a position closer to the second end section in the movement direction of the plunger.

5. The solenoid device according to claim 1, wherein
a vibration damping member that dampens vibration is interposed between the contact section and the second attachment section.

6. The solenoid device according to claim 5, wherein
a first surface of the vibration damping member contacts the contact section, and a second surface of the vibration damping member, which is an opposite surface to the first surface, contacts the second attachment section.

7. The solenoid device according to claim 1, wherein
the contact section is provided to the second attachment section in a state that has play in a direction that intersects a displacement direction of the plunger.

8. The solenoid device according to claim 2, wherein
in the displacement direction of the plunger, the frame is located in the first direction with respect to the contact section,
the contact section has a restricted surface, which is a portion that engages the second attachment section and restricts movement of the contact section in the second direction, and
the restricted surface is provided between the first end section and the second end section and at a position closer to the second end section in the movement direction of the plunger.

9. The solenoid device according to claim 8, wherein
a vibration damping member that dampens vibration is interposed between the contact section and the second attachment section.

10. The solenoid device according to claim 9, wherein
the first end section, the vibration damping member, the restricted surface, and the second end section are located along the second direction in this order.

11. The solenoid device according to claim 2, wherein
a vibration damping member that dampens vibration is interposed between the contact section and the second attachment section.

12. The solenoid device according to claim 1, wherein
the first attachment section and the second attachment section are integral.

13. A medium transport device comprising:
a transport roller pair that nips and transports a medium and that has a first roller that comes into contact with a first surface of the medium and a second roller that comes into contact with a second surface of the medium opposite to the first surface of the medium and
a gate section that is switchable between a first state in which a medium transport path is closed at an upstream side of a medium transport direction from a nip position where the medium is nipped by the transport roller pair, and a second state in which the medium transport path is open, wherein
the gate section is provided on a pivot member that is pivotable with respect to a first rotation shaft, which is a rotation shaft of the first roller and
the pivot member is driven by the solenoid device according to claim 1.

14. A recording device comprising:
a recording section that performs recording on a medium, and
the medium transport device according to claim 13.
